(19) United States
(12) Patent Application Publication
(10) Pub. No.: US 2025/0235811 A1
(43) Pub. Date: Jul. 24, 2025

(54) ACID GAS ADSORPTION DEVICE AND METHOD OF PRODUCING ACID GAS ADSORPTION DEVICE

(71) Applicant: NGK INSULATORS, LTD., Nagoya-City (JP)

(72) Inventors: Yusuke OKUMA, Gifu-Shi (JP); Junichi ANDO, Nagoya-Shi (JP); Shinji FUJISAKI, Kuwana-Shi (JP); Hirofumi KAN, Nagoya-Shi (JP); Michio TAKAHASHI, Nagoya-Shi (JP)

(73) Assignee: NGK INSULATORS, LTD., Nagoya-City (JP)

(21) Appl. No.: 19/174,028

(22) Filed: Apr. 9, 2025

Related U.S. Application Data
(63) Continuation of application No. PCT/JP2023/040393, filed on Nov. 9, 2023.

(30) Foreign Application Priority Data
Nov. 30, 2022 (JP) 2022-190914

(51) Int. Cl. B01D 53/04; B01D 53/62

(52) U.S. Cl. CPC B01D 53/0407; B01D 53/62; B01D 2253/25; B01D 2257/504

(57) ABSTRACT

A acid gas adsorption device includes acid gas-adsorbable particles and an organic binder. The acid gas-adsorbable particles are each capable of adsorbing an acid gas. The organic binder is capable of binding the acid gas-adsorbable particles. The organic binder is soluble in an aprotic polar solvent and is substantially insoluble in a protic polar solvent.

### CROSS-REFERENCE TO RELATED APPLICATIONS

This application is a continuation under 35 U.S.C. 120 of International Application PCT/JP2023/040393 having the International Filing Date of 9 Nov. 2023 and having the benefit of the earlier filing date of Japanese Application No. 2022-190914, filed on 30 Nov. 2022. Each of the identified applications is fully incorporated herein by reference.

### BACKGROUND OF THE INVENTION

### 1. Field of the Invention

The present invention relates to an acid gas adsorption device and a method of producing an acid gas adsorption device.

### 2. Description of the Related Art

In recent years, an attempt has been made to separate and capture an acid gas in the atmosphere in order to reduce an environmental load. Such acid gas is, for example, carbon dioxide (hereinafter sometimes referred to as “CO₂”), which is a main cause of global warming. As a typical example of such attempt, a Carbon dioxide Capture, Utilization and Storage (CCUS) cycle has been known. As a carbon dioxide adsorption device to be used for such separation and capture of carbon dioxide, there has been proposed an absorbent structure for CO₂ capture including an amine compound having a functional mer group capable of absorbing carbon dioxide and an organic binder soluble in a protic polar solvent, in which the organic binder binds and retains the amine compound (see, for example, Patent Literature 1). In such absorbent structure, the organic binder soluble in a protic polar solvent is used, and hence there has been a problem in that a structure in which the organic binder retains the amine compound may be changed, for example, by the influence of water vapor in the atmosphere, and carbon dioxide absorption performance cannot be stably maintained.

### CITATION LIST

### Patent Literature

[PTL 1] WO 2013/119929 A1

### SUMMARY OF THE INVENTION

A primary object of the present invention is to provide an acid gas adsorption device capable of maintaining an excellent acid gas adsorption ability irrespective of the usage environment.
(1) An acid gas adsorption device according to an embodiment of the present invention includes particles each having an acid gas adsorption ability and an organic binder. The organic binder is capable of binding the particles. The organic binder is soluble in an aprotic polar solvent and is substantially insoluble in a protic polar solvent.
(2) The acid gas adsorption device according to the above-mentioned item (1) may have a surface that is capable of being brought into contact with an acid gas. The particles and the organic binder are present on the surface. The surface has one of a three-dimensional network structure or a porous lamellar structure.
(3) In the acid gas adsorption device according to the above-mentioned item (1) or (2), the organic binder may be an organic binder for which at least water is a poor solvent.
(4) The acid gas adsorption device according to any one of the above-mentioned items (1) to (3) may include a base material and an acid gas adsorption layer. The acid gas adsorption layer is arranged on a surface of the base material. The acid gas adsorption layer includes the particles and the organic binder.
(5) The acid gas adsorption device according to any one of the above-mentioned items (1) to (3) may include a molded body including the particles and the organic binder.
(6) The acid gas adsorption device according to any one of the above-mentioned items (1) to (3) may include an acid gas adsorption layer, a dense layer, and a base material in the stated order. The acid gas adsorption layer includes the particles and the organic binder. The dense layer is configured to be denser than the acid gas adsorption layer.
(7) In the acid gas adsorption device according to any one of the above-mentioned items (1) to (6), the acid gas may be carbon dioxide.
(8) A method of producing an acid gas adsorption device according to another aspect of the present invention includes: dispersing particles each having an acid gas adsorption ability in a binder solution having an organic binder dissolved in an aprotic polar solvent, the organic binder being soluble in the aprotic polar solvent and being substantially insoluble in a protic polar solvent; applying the binder solution having dispersed therein the particles to a surface of a base material to form a precursor film; and replacing the aprotic polar solvent in the precursor film with a poor solvent for the organic binder to form an acid gas adsorption layer including the particles each having an acid gas adsorption ability and the organic binder.
(9) A method of producing an acid gas adsorption device according to still another aspect of the present invention includes: mixing particles each having an acid gas adsorption ability, an organic binder that is soluble in an aprotic polar solvent and that is substantially insoluble in a protic polar solvent, an aprotic polar solvent in which the organic binder is soluble and in which the particles are substantially insoluble to prepare a body; molding the body to prepare a precursor including the particles each having an acid gas adsorption ability and the organic binder; and replacing the aprotic polar solvent in the precursor with a poor solvent for the organic binder to prepare a molded body including the particles each having an acid gas adsorption ability and the organic binder.
(10) A method of producing an acid gas adsorption device according to still another aspect of the present invention includes: dispersing a carrier in a binder solution having an organic binder dissolved in an aprotic polar solvent, the organic binder being soluble in the aprotic polar solvent and being substantially insoluble in a protic polar solvent; applying the binder solution having dispersed therein the carrier to a surface of a base material to form a precursor film; replacing the aprotic polar solvent in the precursor film with a poor solvent for the organic binder to form a carrier-containing film including the carrier and the organic binder; and causing an acid gas adsorption compound to be supported on the carrier in the carrier-containing film to form an acid gas adsorption layer including: particles each formed of the acid gas adsorption compound and the carrier; and the organic binder.

According to the embodiment of the present invention, it is possible to achieve the acid gas adsorption device capable of maintaining an excellent acid gas adsorption ability irrespective of the usage environment.

### BRIEF DESCRIPTION OF THE DRAWINGS

FIG. 1 is a schematic perspective view of an acid gas adsorption device according to one embodiment of the present invention.

FIG. 2 is a schematic sectional view of the acid gas adsorption device of FIG. 1.

FIG. 3 is a schematic perspective view of an acid gas adsorption device according to another embodiment of the present invention.

FIG. 4 is a schematic configuration view of an acid gas adsorption device according to still another embodiment of the present invention.

FIG. 5 is a schematic sectional view of an acid gas adsorption device according to still another embodiment of the present invention.

### DESCRIPTION OF THE EMBODIMENTS

Embodiments of the present invention are described below with reference to the drawings. The present invention is not limited to those embodiments. For clearer illustration, some widths, thicknesses, shapes, and the like of respective portions may be schematically illustrated in the drawings in comparison to the embodiments. However, the widths, the thicknesses, the shapes, and the like are merely an example, and do not limit understanding of the present invention.

### A. Overview of Acid Gas Adsorption Device

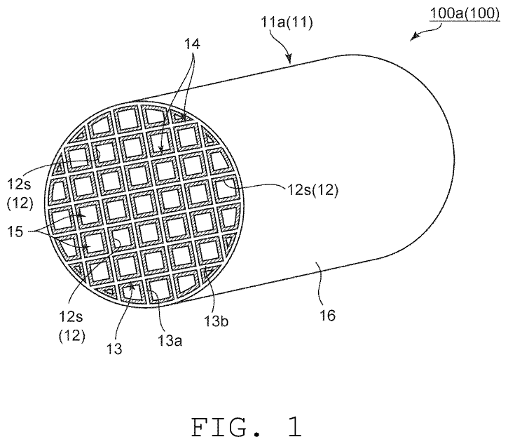

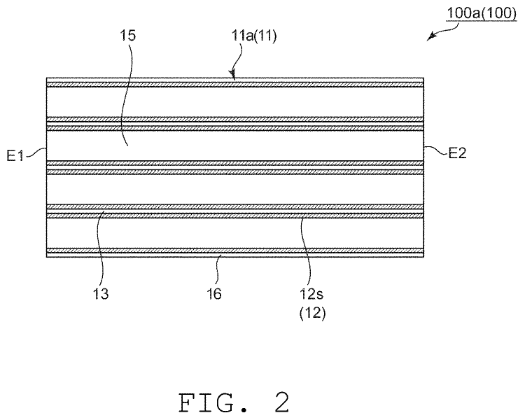

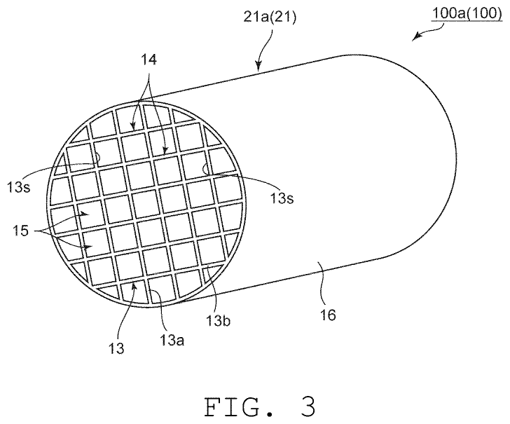

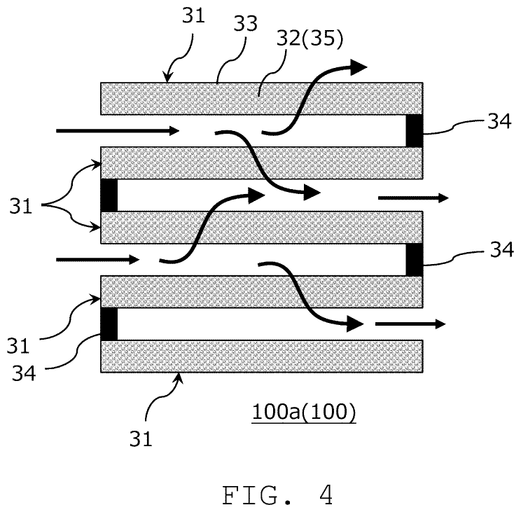

FIG. 1 is a schematic perspective view of an acid gas adsorption device according to one embodiment of the present invention; FIG. 2 is a schematic sectional view of the acid gas adsorption device of FIG. 1; FIG. 3 is a schematic perspective view of an acid gas adsorption device according to another embodiment of the present invention; and FIG. 4 is a schematic configuration view of an acid gas adsorption device according to still another embodiment of the present invention.

The acid gas adsorption device according to one embodiment of the present invention can separate (remove) an acid gas from the gas to be treated. An acid gas adsorption device 100 includes particles each having an acid gas adsorption ability (hereinafter referred to as “acid gas-adsorbable particles”) and an organic binder. The acid gas-adsorbable particles are each capable of adsorbing the acid gas. The organic binder is capable of binding the acid gas-adsorbable particles. The organic binder is soluble in an aprotic polar solvent and is substantially insoluble in a protic polar solvent. That is, the organic binder has resistance to water (water resistance), which is a protic polar solvent. With such configuration, the organic binder is substantially insoluble in the protic polar solvent and has water resistance, and hence, for example, swelling of the organic binder caused by water vapor in the atmosphere can be suppressed. Accordingly, volume expansion and/or a reduction in strength of the organic binder can be suppressed. Besides, a structure in which the organic binder binds and retains the acid gas-adsorbable particles can be prevented from being changed. As a result, an excellent acid gas adsorption ability can be maintained irrespective of the usage environment.

Such acid gas adsorption device can be produced by replacing the aprotic polar solvent, in which the organic binder is dissolved, with a poor solvent such as water, in which the organic binder has a low solubility, to thereby precipitate the organic binder. The organic binder having been precipitated is not dissolved in the protic polar solvent (e.g., water or an alcohol), and hence an acid gas adsorption device having an acid gas adsorption ability free of the influence of the protic polar solvent (specifically, an acid gas adsorption device excellent in water resistance) can be achieved without heat treatment and with low energy.

In one embodiment, the acid gas adsorption device 100 has a surface capable of being brought into contact with an acid gas. The acid gas-adsorbable particles and the organic binder are present on the surface capable of being brought into contact with an acid gas. The surface has a three-dimensional network structure or a porous lamellar structure. Accordingly, the acid gas can be efficiently diffused from the surface capable of being brought into contact with an acid gas to an inside. In particular, the organic binder has water resistance, and hence the surface capable of being brought into contact with an acid gas can stably maintain such microstructure irrespective of the usage environment. The surface capable of being brought into contact with an acid gas preferably has the three-dimensional network structure.

The three-dimensional network structure typically has a plurality of pores.

The plurality of pores each typically have a substantially circular shape or a substantially elliptic shape in a cross section.

The average pore diameter of the three-dimensional network structure is, for example, from 0.1 μm to 10 μm, preferably from 0.5 μm to 5.0 μm. The average pore diameter is calculated, for example, by taking a SEM image of a cross section, which is obtained by cutting a surface having the three-dimensional network structure in a thickness direction, at a magnification of 300 times, and subjecting the SEM image to binarization processing.

The porosity of the three-dimensional network structure is, for example, from 15% to 90%, preferably from 40% to 80%, still more preferably from 45% to 75%. The porosity may be measured, for example, by mercury porosimetry.

The bulk density of the three-dimensional network structure is, for example, from 0.05 g/cm³ to 1.600 g/cm³, preferably from 0.2 g/cm³ to 1.5 g/cm³, more preferably from 0.25 g/cm³ to 1.3 g/cm³.

The porous lamellar structure typically has a plurality of first pores, which are relatively large, and a plurality of second pores, which are relatively small.

The plurality of first pores each typically have a substantially teardrop shape in a cross section. The length of each of the first pores is, for example, from 1 times to 30 times, preferably from 2 times to 10 times as large as the width of each of the first pores (dimension in a direction perpendicular to a length direction). The dimensions (diameters) of the pores are calculated, for example, by taking a SEM image of a cross section, which is obtained by cutting a surface having the porous lamellar structure in a thickness direction, at a magnification of 300 times, and subjecting the SEM image to binarization processing.

The average length of the plurality of first pores is, for example, from 10 μm to 1,000 μm, preferably from 50 μm to 500 μm. The average width of the plurality of first pores is, for example, from 1 μm to 100 μm, preferably from 10 μm to 50 μm.

The plurality of second pores each typically have a substantially circular shape or a substantially elliptic shape in the cross section. When the second pores each have a substantially elliptic shape, the ratio of the long diameter of each of the second pores to the short diameter thereof is less than the lower limit of the above-mentioned ratio of the length of each of the first pores to the width thereof.

The average diameter of the plurality of second pores is, for example, from 0.1 μm to 10 μm, preferably from 0.5 μm to 5 μm.

The average length of the plurality of first pores is, for example, 10 times or more, preferably 50 times or more, and is, for example, 1,000 times or less, preferably 500 times or less as large as the average diameter of the plurality of second pores (average length of first pores/average diameter of second pores).

Examples of the acid gas serving as an adsorption target of the acid gas adsorption device 100 include carbon dioxide (CO₂), hydrogen sulfide, sulfur dioxide, nitrogen dioxide, dimethyl sulfide (DMS), and hydrogen chloride. In one embodiment, the acid gas is carbon dioxide (CO₂), and a gas fluid is a CO₂-containing gas. The CO₂-containing gas may include nitrogen in addition to CO₂. The CO₂-containing gas is typically air (atmosphere). The concentration of CO₂ in the CO₂-containing gas before being supplied to the acid gas adsorption device is, for example, 100 ppm (on a volume basis) or more and 2 vol % or less.

### A-1. Acid Gas-Adsorbable Particles

The acid gas-adsorbable particles are each in a solid state under normal temperature and normal pressure (23° C., 0.1 MPaA (absolute pressure)). The acid gas adsorption device 100 typically includes a plurality of acid gas-adsorbable particles. The acid gas-adsorbable particles, under a state of being incorporated in the acid gas adsorption device 100, may be primary particles, or may be secondary particles in which a plurality of primary particles aggregate.

In one embodiment, the acid gas-adsorbable particles each include an acid gas adsorption compound and a carrier on which the acid gas adsorption compound is supported. In some cases, however, the acid gas-adsorbable particles are each formed only of the acid gas adsorption compound and are each free of the carrier. That is, the acid gas-adsorbable particles may also be each formed only of an acid gas adsorption compound that is a solid under normal temperature and normal pressure.

When the acid gas is CO₂, the acid gas adsorption compound is a CO₂ adsorption compound.

Any appropriate compound capable of adsorbing and desorbing CO₂ may be adopted as the CO₂ adsorption compound. Examples of the CO₂ adsorption compound include: nitrogen-containing compounds; alkali compounds, such as sodium hydroxide and potassium hydroxide; carbonic acid salts, such as calcium carbonate and potassium carbonate; hydrogen carbonate salts, such as calcium hydrogen carbonate and potassium hydrogen carbonate; metal organic flameworks (MOF), such as MOF-74, MOF-200, and MOF-210; zeolite; activated carbon; and nitrogen-doped carbon. The CO₂ adsorption compounds may be used alone or in combination thereof.

Of those CO₂ adsorption compounds, a nitrogen-containing compound is preferred. More specific examples of the nitrogen-containing compound include: primary amines, such as monoethanolamine and polyvinylamine; secondary amines, such as diethanolamine, a cyclic amine, and N-(3-aminopropyl) diethanolamine; tertiary amines, such as methyldiethylamine and triethanolamine; ethyleneamine compounds such as tetraethylenepentamine; aminosilane coupling agents, such as aminopropyltrimethoxysilane, 3-aminopropyltriethoxysilane, N-(2-aminoethyl)-3-aminopropyl-trimethoxysilane, and polyethyleneimine-trimethoxysilane; organic polymers having a primary amino group to a tertiary amino group; organic monomers having a primary amino group to a tertiary amino group; piperazine compounds such as 1-(2-hydroxyethyl) piperazine; and organic/inorganic compounds to each of which an amino group is added as a substituent. The nitrogen-containing compounds may be used alone or in combination thereof. Of those nitrogen-containing compounds, organic monomers having a primary amino group to a tertiary amino group and organic polymers having a primary amino group to a tertiary amino group are preferred.

Specific examples of the organic monomers having a primary amino group to a tertiary amino group include ethyleneimine and styrene to which an amino group is added.

Specific examples of the organic polymers having a primary amino group to a tertiary amino group include linear polyethyleneimine, branched polyethyleneimine, polyamidoamine, and polystyrene to which an amino group is added. The weight average molecular weight Mw (in terms of polystyrene) of the organic polymer is, for example, 1,000 or more, preferably 50,000 or more, and is, for example, 1,000,000 or less, preferably 300,000 or less.

In one embodiment, the acid gas adsorption compound is substantially insoluble in the protic polar solvent (typically, water) and the aprotic polar solvent.

The solubility of the acid gas adsorption compound in water at 25° C. is, for example, 0.1 g/100 g-H₂O or less, preferably 0.05 g/100 g-H₂O or less. When the solubility of the acid gas adsorption compound in water is equal to or less than the above-mentioned upper limits, excellent water resistance can be stably imparted to the acid gas adsorption device. The lower limit of the solubility of the acid gas adsorption compound in water at 25° C. is typically 0.01 g/100 g-H₂O or more.

The solubility of the acid gas adsorption compound in the aprotic polar solvent at 25° C. is, for example, 1 g/100 g-aprotic polar solvent or less, preferably 0.5 g/100 g-aprotic polar solvent or less. When the solubility of the acid gas adsorption compound in the aprotic polar solvent is equal to or less than the above-mentioned upper limits, the dissolution of the acid gas adsorption compound in the aprotic polar solvent can be suppressed at the time of the production of the acid gas adsorption device. The lower limit of the solubility of the acid gas adsorption compound in the aprotic polar solvent at 25° C. is typically 0.01 g/100 g-aprotic polar solvent or more.

The solubility parameter of the acid gas adsorption compound at 25° C. is, for example, 7 or more, preferably 8 or more, and is, for example, 20 or less, preferably 15 or less. The solubility parameter may be calculated, for example, by a Hildebrand method (the same applies hereinafter).

Any appropriate carrier capable of supporting the acid gas adsorption compound may be adopted as the carrier. The carrier is preferably a porous carrier. When the carrier is a porous carrier, mesopores can be formed on the surface capable of being brought into contact with an acid gas. Examples of the porous carrier include: metal organic frameworks (MOF), such as MOF-74, MOF-200, and MOF-210; activated carbon; nitrogen-doped carbon; porous silica; porous alumina; zeolite; a carbon nanotube; and a polymer. Those porous carriers may be used alone or in combination thereof. A material different from the acid gas adsorption compound is preferably adopted as the porous carrier. Of those porous carriers, porous silica is more preferred.

The BET specific surface area of the porous carrier is, for example, 50 m²/g or more, preferably 500 m²/g or more. When the surface area of the porous carrier is equal to or more than the above-mentioned lower limits, the acid gas adsorption compound can be stably supported, and an increase in capture rate of CO₂ can be achieved. The upper limit of the BET specific surface area of the porous carrier is typically 2,000 m²/g or less.

In addition, from the viewpoint of thermal conductivity, a metal material may be adopted. Examples thereof include: iron and steel materials, such as carbon steel and alloy steel; and non-ferrous metals, such as copper, aluminum, and nickel, and alloys thereof. In the case of the metal material, the shape of the carrier is not limited to a porous shape.

The acid gas-adsorbable particles are configured by any appropriate combination of the acid gas adsorption compound and the carrier. Specific examples of the acid gas-adsorbable particles include an amine-supporting polymer, an amine-supporting MOF, and amine-supporting nitrogen-doped carbon.

The mass ratio of the acid gas adsorption compound to the carrier (acid gas adsorption compound/carrier) is, for example, 0.1 or more, preferably 1 or more, and is, for example, 5 or less, preferably 3 or less.

### A-2. Organic Binder

Any appropriate organic compound capable of binding the acid gas-adsorbable particles may be adopted as the organic binder. The organic binder is soluble in the aprotic polar solvent and is substantially insoluble in the protic polar solvent. Examples of the organic binder include: fluoropolymers, such as polyvinylidene fluoride (PVDF), polytetrafluoroethylene (PTFE), a perfluoroalkoxy alkane (PFA), a perfluoroethylene propene copolymer (FEP), an ethylene tetrafluoroethylene copolymer (ETFE), and polyvinyl fluoride (PVF); and amorphous plastics, such as polyethersulfone (PES), polysulfone, polyvinylidene chloride, polyimide, and polyvinyl chloride. Those organic binders may be used alone or in combination thereof.

Of those organic binders, organic binders for each of which at least water is a poor solvent (organic binders each substantially insoluble in water) are preferred, fluoropolymers are more preferred, and polyvinylidene fluoride is still more preferred. When the organic binder includes the fluoropolymer (polyvinylidene fluoride), excellent heat resistance and water resistance can be imparted to the acid gas adsorption device.

The weight average molecular weight Mw (in terms of polystyrene) of the organic binder is, for example, 10,000 or more, preferably 200,000 or more, and is, for example, 10,000,000 or less, preferably 1,000,000 or less.

The solubility of the organic binder in the protic polar solvent (typically, water) at 25° C. is, for example, 0.1 g/100 g-protic polar solvent or less, preferably 0.05 g/100 g-protic polar solvent or less. When the solubility of the organic binder in the protic polar solvent (typically, water) is equal to or less than the above-mentioned upper limits, excellent water resistance can be stably imparted to the acid gas adsorption device. The lower limit of the solubility of the organic binder in the protic polar solvent (typically, water) at 25° C. is typically 0.01 g/100 g-protic polar solvent or more.

The solubility parameter of the organic binder at 25° C. is, for example, 9 or more, preferably 10 or more, and is, for example, 15 or less, preferably 13 or less.

### B. Acid Gas Adsorption Device Including Base Material and Acid Gas Adsorption Layer

As illustrated in FIG. 1 and FIG. 2, in one embodiment, the acid gas adsorption device 100 includes a base material 11 and an acid gas adsorption layer 12 including the above-mentioned acid gas-adsorbable particles and the above-mentioned organic binder. In the illustrated example, the acid gas adsorption layer 12 is arranged on the surface of the base material 11.

### B-1. Base Material

The structure of the base material 11 is not particularly limited, and is, for example, a honeycomb-like structure, a filter structure such as a filtration cloth, or a pellet structure. In the illustrated example, the base material 11 is a honeycomb-like base material 11a. The honeycomb-like base material 11a and the acid gas adsorption layer 12 form a honeycomb structure. The honeycomb-like base material 11a includes a partition wall 13 that defines a plurality of cells 14.

The cells 14 each extend from a first end surface E1 (inflow end surface) of the honeycomb-like base material 11a to a second end surface E2 (outflow end surface) thereof in a length direction (axial direction) of the honeycomb-like base material 11a (see FIG. 2). The cells 14 each have any appropriate shape in a cross section in a direction perpendicular to the length direction of the honeycomb-like base material 11a. The sectional shapes of the cells are each, for example, a triangle, a quadrangle, a pentagon, a hexagon, a higher polygon, a circle, or an ellipse. The sectional shapes and sizes of the cells may be all the same, or may be at least partly different. Of such sectional shapes of the cells, a hexagon or a quadrangle is preferred, and a square, a rectangle, or a hexagon is more preferred.

A cell density in a cross section in the direction perpendicular to the length direction of the honeycomb-like base material (specifically, the number of the cells 14 per unit area) may be appropriately set depending on the purposes. The cell density may be, for example, from 4 cells/cm² to 320 cells/cm². When the cell density falls within such range, the strength and effective geometric surface area (GSA) of the honeycomb-like base material can be sufficiently ensured.

The honeycomb-like base material 11a has any appropriate shape (overall shape). The shape of the honeycomb-like base material is, for example, a cylinder with a circle as its bottom, an elliptic cylinder with an ellipse as its bottom, a prismatic column with a polygon as its bottom, or a column with an indefinite shape as its bottom. The honeycomb-like base material 11a of the illustrated example has a cylindrical shape. The outer diameter and length of the honeycomb-like base material may be appropriately set depending on the purposes. Although not shown, the honeycomb-like base material may have a hollow area in a center portion thereof in a cross section in the direction perpendicular to the length direction.

The honeycomb-like base material 11a typically includes: an outer wall 16; and a partition wall 13 positioned inside the outer wall 16. In the illustrated example, the outer wall 16 and the partition wall 13 are integrally formed. The outer wall 16 and the partition wall 13 may be separate bodies.

In the illustrated example, the outer wall 16 has a cylindrical shape. The thickness of the outer wall 16 may be set to any appropriate thickness. The thickness of the outer wall 16 is, for example, from 0.1 mm to 10 mm.

The partition wall 13 defines the plurality of cells 14. More specifically, the partition wall 13 has a first partition wall 13a and a second partition wall 13b perpendicular to each other, and the first partition wall 13a and the second partition wall 13b define the plurality of cells 14. The sectional shapes of the cells 14 are each substantially a quadrangle except for a portion in which the first partition wall 13a and the second partition wall 13b are each brought into contact with the outer wall 16. The configuration of the partition wall is not limited to the partition wall 13 described above. The partition wall may have a first partition wall extending in a radial direction and a second partition wall extending in a circumferential direction, which define a plurality of cells.

The thickness of the partition wall 13 may be appropriately set depending on the applications of the acid gas adsorption device. The thickness of the partition wall 13 is typically smaller than the thickness of the outer wall 16. The thickness of the partition wall 13 is, for example, from 0.03 mm to 0.6 mm. The thickness of the partition wall is measured, for example, through sectional observation with a scanning electron microscope (SEM). When the thickness of the partition wall falls within such range, the honeycomb-like base material can achieve sufficient mechanical strength, and can also achieve a sufficient opening area (total area of the cells in a cross section).

The porosity of the partition wall 13 may be appropriately set depending on the purposes. The porosity of the partition wall 13 is, for example, 15% or more, preferably 20% or more, and is, for example, 70% or less, preferably 45% or less. The porosity may be measured, for example, by mercury porosimetry.

The bulk density of the partition wall 13 may be appropriately set depending on the purposes. The bulk density is, for example, 0.10 g/cm³ or more, preferably 0.20 g/cm³ or more, and is, for example, 0.60 g/cm³ or less, preferably 0.50 g/cm³ or less. The bulk density may be measured, for example, by mercury porosimetry.

A material for forming the partition wall 13 is typically, for example, a ceramic. Examples of the ceramic include silicon carbide, a silicon-silicon carbide-based composite material, cordierite, mullite, alumina, silicon nitride, spinel, a silicon carbide-cordierite-based composite material, lithium aluminum silicate, and aluminum titanate. Those materials for forming the partition walls may be used alone or in combination thereof. Of those materials for forming the partition walls, cordierite, alumina, mullite, silicon carbide, a silicon-silicon carbide-based composite material, and silicon nitride are preferred, and cordierite is more preferred.

### B-2. Acid Gas Adsorption Layer

In one embodiment, the acid gas adsorption layer 12 is formed on the surface of the partition wall 13. In the honeycomb-like base material 11a, a gas flow passage 15 is formed in a portion (typically, a center portion) in a cross section of the cell 14 in which the acid gas adsorption layer 12 is not formed. The acid gas adsorption layer 12 may be formed on the entire inner surface of the partition wall 13 (specifically, so as to surround the gas flow passage 15) as in the illustrated example, or may be formed on part of the surface of the partition wall. When the acid gas adsorption layer 12 is formed on the entire inner surface of the partition wall 13, adsorption efficiency of the acid gas (typically, CO₂) can be improved.

The gas flow passage 15 extends from the first end surface E1 (inflow end surface) to the second end surface E2 (outflow end surface) as with the cells 14. Examples of the sectional shape of the gas flow passage 15 include the same sectional shapes as those of the cells 14 described above. Of those, a hexagon or a quadrangle is preferred, and a square, a rectangle, or a hexagon is more preferred. The sectional shapes and sizes of the respective gas flow passages 15 may be all the same, or may be at least partly different.

Typically, a gas to be treated including the acid gas is supplied to the cells 14 (more specifically, the gas flow passage 15) in an adsorption step described later, and a desorption gas is supplied thereto in a desorption step described later.

The acid gas adsorption layer 12 includes the above-mentioned acid gas-adsorbable particles and the above-mentioned organic binder. Accordingly, the acid gas adsorption layer, which has come to the end of the lifetime, can be easily removed by dissolving the organic binder in the acid gas adsorption layer in the aprotic polar solvent. Thus, the acid gas adsorption layer can be regenerated with low energy.

A surface 12s of the acid gas adsorption layer 12 on an opposite side to the partition wall 13 faces the gas flow passage 15, and is capable of being brought into contact with the acid gas to be supplied in the adsorption step. The acid gas-adsorbable particles and the organic binder are present on the surface 12s. That is, the surface 12s of the acid gas adsorption layer 12 is the “surface capable of being brought into contact with an acid gas” described in the above-mentioned section A, and preferably has the above-mentioned three-dimensional network structure or the above-mentioned porous lamellar structure.

The acid gas adsorption layer 12 may include any appropriate additive in addition to the acid gas-adsorbable particles and the organic binder.

When the total of the acid gas-adsorbable particles, the organic binder, and the additive is defined as 100 vol %, the total content ratio of the acid gas-adsorbable particles and the organic binder in the acid gas adsorption layer 12 is, for example, 30 vol % or more, preferably 50 vol % or more, and is, for example, 100 vol % or less, preferably 99 vol % or less. The volume percentage may be measured, for example, through microstructure observation and elemental analysis.

When the entirety of the acid gas adsorption layer 12 including pores is defined as 100 vol %, the total content ratio of the acid gas-adsorbable particles and the organic binder is, for example, 10 vol % or more, preferably 30 vol % or more, more preferably 40 vol % or more, still more preferably 50 vol % or more, particularly preferably 60 vol % or more, and is, for example, 90 vol % or less, preferably 85 vol % or less.

When the total of the acid gas-adsorbable particles, the organic binder, and the additive is defined as 100 vol %, the content ratio of the acid gas-adsorbable particles in the acid gas adsorption layer 12 is, for example, 5 vol % or more, preferably 30 vol % or more. When the content ratio of the acid gas-adsorbable particles is equal to or more than the above-mentioned lower limits, the acid gas adsorption performance of the acid gas adsorption device can be sufficiently ensured. The upper limit of the content ratio of the acid gas-adsorbable particles is typically 85 vol % or less.

When the entirety of the acid gas adsorption layer 12 including pores is defined as 100 volt, the content ratio of the acid gas-adsorbable particles is, for example, 9 vol % or more, preferably 10 vol % or more, more preferably 15 vol % or more, and is, for example, 30 vol % or less, preferably 25 vol % or less.

When the total of the acid gas-adsorbable particles, the organic binder, and the additive is defined as 100 volt, the content ratio of the organic binder in the acid gas adsorption layer 12 is, for example, 5 vol % or more, preferably 15 vol % or more. When the content ratio of the organic binder is equal to or more than the above-mentioned lower limits, the escaping of the acid gas-adsorbable particles from the acid gas adsorption layer can be suppressed in the adsorption step and/or the desorption step described later. The upper limit of the content ratio of the organic binder is typically 70 vol % or less.

When the entirety of the acid gas adsorption layer 12 including pores is defined as 100 volt, the content ratio of the organic binder is, for example, 1 vol % or more, preferably 5 vol % or more, and is, for example, 30 vol % or less, preferably 10 vol % or less.

The acid gas adsorption layer 12 typically has pores communicating to each other. The porosity of the acid gas adsorption layer 12 is, for example, 10% or more and 90% or less, preferably 10% or more and 60% or less, more preferably 15% or more and 40% or less.

The thickness of the acid gas adsorption layer 12 is not particularly limited, but is, for example, 10 μm or more, preferably 50 μm or more, and is, for example, 1,000 μm or less, preferably 500 μm or less.

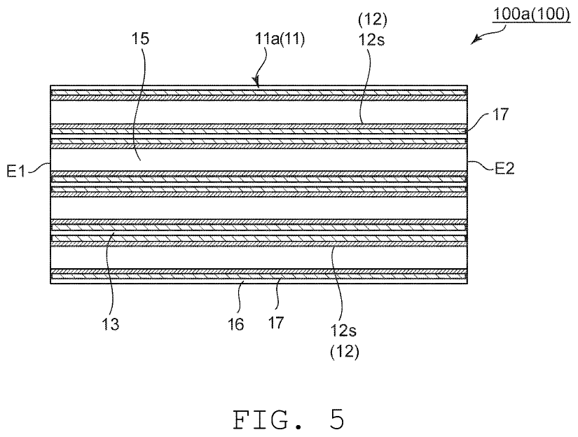

As illustrated in FIG. 5, in another embodiment, the acid gas adsorption device 100 further includes a dense layer 17 in addition to the base material 11 and the acid gas adsorption layer 12. The dense layer 17 is arranged between the base material 11 and the acid gas adsorption layer 12. In other words, the acid gas adsorption device 100 includes the acid gas adsorption layer 12, the dense layer 17, and the base material 11 (typically, the partition wall 13) in the stated order. The dense layer 17 is configured to be denser than the acid gas adsorption layer 12. The porosity of the dense layer 17 is lower than the porosity of the acid gas adsorption layer 12. When the dense layer is arranged between the base material and the acid gas adsorption layer, an increase in adhesive strength of the acid gas adsorption layer can be achieved, and an increase in thickness of the acid gas adsorption layer can be achieved. Accordingly, the adsorption ability of the acid gas adsorption device can be improved.

In the illustrated example, the dense layer 17 is arranged on the surface of the partition wall 13. The dense layer 17 may be formed on the entire inner surface of the partition wall 13 as in the illustrated example, or may be formed on part of the surface of the partition wall 13. The acid gas adsorption layer 12 is arranged on the surface of the dense layer 17. The acid gas adsorption layer 12 may be formed on the entire surface of the dense layer 17 as in the illustrated example, or may be formed on part of the surface of the dense layer 17.

A material of the dense layer 17 is not particularly limited as long as the material is soluble in an aprotic solvent. An example of the material of the dense layer 17 is the above-mentioned organic binder. The materials of the dense layer 17 may be used alone or in combination thereof. Of the materials of the dense layer 17, the above-mentioned organic binder is preferred. The organic binder in the dense layer 17 and the organic binder in the acid gas adsorption layer 12 may be the same as or different from each other.

The thickness of the dense layer 17 is, for example, from 10 times to 1,000 times, preferably from 100 times to 500 times as large as the thickness of the acid gas adsorption layer 12. The thickness of the dense layer 17 is not particularly limited, but is, for example, 0.1 μm or more, preferably 1 μm or more, and is, for example, 10 μm or less, preferably 5 μm or less. For example, the thickness is calculated as an average value of layer thicknesses measured at three or more points in a sectional SEM image.

### B-3. Acid Gas Adsorption Device Including Pellet-Like Base Material

The acid gas adsorption device 100 illustrated in FIG. 1 and FIG. 2 includes the honeycomb-like base material 11a as the base material 11 as described above, but the shape of the base material 11 is not limited thereto. In one embodiment, the base material 11 is a pellet-like base material.

As illustrated in FIG. 4, an acid gas adsorption device including the pellet-like base material is typically, for example, an acid gas adsorption device including a plurality of adsorption material layers 31. The plurality of adsorption material layers 31 are laminated on one another in a thickness direction so as to be spaced apart from one another. In the illustrated example, five adsorption material layers 31 are arranged in parallel, but the number of the adsorption material layers 31 is not limited thereto. The number of the adsorption material layers 31 is, for example, 5 or more, preferably 10 or more, more preferably 20 or more. A space between the adjacent adsorption material layers 31 out of the plurality of adsorption material layers 31 is, for example, 0.5 cm or more and 1.5 cm or less.

The plurality of adsorption material layers 31 each include a plurality of pellet structures 32 and a flexible fiber member 33. The plurality of pellet structures 32 are filled in an inside of the flexible fiber member 33 having a hollow shape (bag shape). The plurality of pellet structures 32 each include the pellet-like base material and the acid gas adsorption layer.

Although not shown, the average primary particle diameter of the pellet-like base material is, for example, 60 μm or more and 1, 200 μm or less. The range of the porosity of the pellet-like base material is the same as the above-mentioned range of the porosity of the partition wall, and the range of the bulk density of the pellet-like base material is the same as the above-mentioned range of the bulk density of the partition wall. A material for forming the pellet-like base material is, for example, the same ceramic as the material for forming the partition wall.

In each of the pellet structures 32, the acid gas adsorption layer is formed on the outer peripheral surface of the pellet-like base material. The acid gas adsorption layer is described in the same manner as the acid gas adsorption layer 12 in the above-mentioned section B-2.

Any appropriate value may be adopted for the filling ratio of the pellet structures 32 in the adsorption material layer 31.

The flexible fiber member 33 permits passage of a gas and controls passage of the pellet structures. The flexible fiber member 33 is typically formed into a hollow shape (bag shape) capable of accommodating the plurality of pellet structures 32. The flexible fiber member 33 may be a woven fabric or a non-woven fabric. A material of the flexible fiber member 33 is, for example, an organic fiber or a natural fiber, and is preferably a polyethylene terephthalate fiber, a polyethylene fiber, or a cellulose-based fiber. The thickness of the flexible fiber member 33 is, for example, 25 μm or more and 500 μm or less.

The acid gas adsorption device 100 of the illustrated example further includes a plurality of spacers 34. The spacers 34 are each sandwiched between the adjacent adsorption material layers 31 out of the plurality of adsorption material layers 31. Thus, a space between the adjacent adsorption material layers can be stably ensured. In one embodiment, the plurality of adsorption material layers 31 and the plurality of spacers 34 are arranged in a substantially zigzag shape as seen from a direction perpendicular to a thickness direction of the adsorption material layer 31 (in a sheet depth direction of FIG. 4).

An example of the acid gas adsorption device 100 including such pellet structures 32 is a gas separation unit described in WO 2014/170184 A1, the description of which is incorporated herein by reference in its entirety.

### B-4. Method of Producing Acid Gas Adsorption Device Including Base Material and Acid Gas Adsorption Layer

Next, a method of producing the acid gas adsorption device 100 including the base material 11 and the acid gas adsorption layer 12 is described.

The method of producing the acid gas adsorption device 100 including the base material 11 and the acid gas adsorption layer 12 includes the steps of: dispersing the acid gas-adsorbable particles in a binder solution; applying the binder solution having dispersed therein the acid gas-adsorbable particles to the surface of the base material 11; and replacing an aprotic polar solvent in a precursor film formed on the surface of the base material 11 to form the acid gas adsorption layer 12.

In such method of producing the acid gas adsorption device 100, first, a binder solution is prepared by dissolving the above-mentioned organic binder in the aprotic polar solvent.

The aprotic polar solvent can dissolve the above-mentioned organic binder therein and cannot dissolve the above-mentioned acid gas-adsorbable particles (more specifically, the acid gas adsorption compound) therein.

A solubility parameter distance between the organic binder and the aprotic polar solvent at 25° C. is, for example, 3 or less, preferably 2 or less. When the solubility parameter distance between the organic binder and the aprotic polar solvent is equal to or less than the above-mentioned upper limits, the organic binder can be smoothly dissolved in the aprotic polar solvent. The lower limit of the solubility parameter distance between the organic binder and the aprotic polar solvent at 25° C. is typically 0 or more. The solubility parameter distance may be calculated, for example, by a Hildebrand method.

A solubility parameter distance between the acid gas adsorption compound and the aprotic polar solvent at 25° C. is, for example, 2 or more, preferably 3 or more, more preferably 4 or more. When the solubility parameter distance between the acid gas adsorption compound and the aprotic polar solvent is equal to or more than the above-mentioned lower limits, the dissolution of the acid gas adsorption compound in the aprotic polar solvent can be suppressed. The upper limit of the solubility parameter distance between the acid gas adsorption compound and the aprotic polar solvent at 25° C. is typically 10 or less.

Any appropriate organic solvent may be adopted as the aprotic polar solvent. Examples of the aprotic polar solvent include N-methyl-2-pyrrolidone (NMP), dimethylformamide (DMF), dimethylacetmide (DMA), dimethylsulfoxide (DMSO), and tetrahydrofuran (THF). Those aprotic polar solvents may be used alone or in combination thereof.

Of those aprotic polar solvents, N-methyl-2-pyrrolidone (NMP) is preferred. When the aprotic polar solvent includes NMP, the organic binder (particularly, PVDF) can be more smoothly dissolved therein, and the acid gas adsorption compound can be stably prevented from being dissolved therein.

Next, the above-mentioned acid gas-adsorbable particles are added to be dispersed in the binder solution.

A solution of the organic binder in the aprotic polar solvent in which the acid gas-adsorbable particles are dispersed (particle-dispersed binder solution) is applied to the surface of the base material 11 by any appropriate method.

The base material 11 is typically produced separately by the following method. First, a binder and water or an organic solvent are added to material powder including ceramic powder as required. The resultant mixture is kneaded to provide a body, and the body is molded (typically extruded) into a desired shape. After that, the body is dried, and is fired as required. Thus, the base material 11 (typically, the honeycomb-like base material 11a or the pellet-like base material) is produced. When the firing is adopted, the body is fired at, for example, from 1,200° C. to 1, 500° C. A firing time period is, for example, 1 hour or more and 20 hours or less.

Any appropriate method may be selected as an application method for the particle-dispersed binder solution depending on the shape of the base material 11. In one embodiment, the base material 11 (typically, the honeycomb-like base material 11a or the pellet-like base material) is immersed in the particle-dispersed binder solution.

The application method is not limited to the immersion. For example, when the base material 11 is the honeycomb-like base material 11a, the particle-dispersed binder solution may be caused to flow through each of the cells 14 of the honeycomb-like base material 11a. Thus, the particle-dispersed binder solution can be smoothly applied to the surface of the partition wall.

The number of times of the application of the particle-dispersed binder solution is appropriately changed depending on a desired thickness of the acid gas adsorption layer 12.

In this manner, the particle-dispersed binder solution is applied to the surface of the base material 11 (typically, the surface of the partition wall 13 of the honeycomb-like base material 11a or the outer peripheral surface of the pellet-like base material). Thus, a precursor film is formed. The precursor film includes the above-mentioned acid gas-adsorbable particles, the above-mentioned organic binder, and the above-mentioned aprotic polar solvent.

Next, the aprotic polar solvent in the precursor film is replaced with a poor solvent for the organic binder.

The poor solvent dissolves the organic binder therein to a smaller extent than the above-mentioned aprotic polar solvent (good solvent), and the organic binder is substantially insoluble in the poor solvent. A solubility parameter distance between the organic binder and the poor solvent at 25° C. is typically larger than the solubility parameter distance between the organic binder and the aprotic polar solvent (good solvent). The solubility parameter distance between the organic binder and the poor solvent at 25° C. is, for example, 2 or more, preferably 3 or more, more preferably 4 or more.

Examples of the poor solvent include: protic polar solvents, water and alcohols including ethanol, butanol, and such isopropyl alcohol (IPA); and fluorocarbons, such as hydrochlorofluorocarbons (HCFC), hydrofluorocarbons (HFC), and hydrofluoroolefins (HFO). Those poor solvents may be used alone or in combination thereof. Of those poor solvents, water is preferred.

Through replacement of the aprotic polar solvent, a film stable for a protic solvent is obtained.

Thus, the acid gas adsorption layer 12 is formed on the surface of the base material 11 (typically, the surface of the partition wall 13 of the honeycomb-like base material 11a or the outer peripheral surface of the pellet-like base material). After that, the acid gas adsorption layer 12 is dried as required.

A structure including: the base material 11; and the acid gas adsorption layer 12 arranged on the surface of the base material 11 is produced in this manner.

More specifically, when the base material 11 is the honeycomb-like base material 11a, the honeycomb structure including: the honeycomb-like base material 11a; and the acid gas adsorption layer 12 arranged on the surface of the partition wall 13 is produced. That is, the acid gas adsorption device 100 formed of the honeycomb structure is produced.

In addition, when the base material 11 is the pellet-like base material, the pellet structures each including: the pellet-like base material; and the acid gas adsorption layer arranged on the outer peripheral surface of the pellet-like base material are produced. Such pellet structures are suitably used for the production of the acid gas adsorption device illustrated in FIG. 4.

In addition, the method of producing the acid gas adsorption device including the base material 11 and the acid gas adsorption layer 12 is not limited to the above-mentioned embodiment. A method of producing the acid gas adsorption device according to another embodiment includes the steps of: dispersing a carrier in a binder solution; applying the binder solution having dispersed therein the carrier to the surface of the base material 11; replacing an aprotic polar solvent in a precursor film formed on the surface of the base material 11 to form a carrier-containing film; and causing an acid gas adsorption compound to be supported on the carrier in the carrier-containing film to form the acid gas adsorption layer 12.

In such method of producing the acid gas adsorption device, first, a binder solution is prepared in the same manner as described above. Next, the above-mentioned carrier is added to the binder solution and stirred.

Thus, the carrier is dispersed in the binder solution, and a binder solution in which the carrier is dispersed (carrier-dispersed binder solution) is prepared.

Next, the carrier-dispersed binder solution is applied to the surface of the above-mentioned base material 11 by the above-mentioned application method.

In this manner, the carrier-dispersed binder solution is applied to the surface of the base material 11 (typically, the surface of the partition wall 13 of the honeycomb-like base material 11a or the outer peripheral surface of the pellet-like base material). Thus, a precursor film is formed. The precursor film includes the above-mentioned carrier, the above-mentioned organic binder, and the above-mentioned aprotic polar solvent.

Next, the aprotic polar solvent in the precursor film is replaced with the above-mentioned poor solvent.

Thus, the carrier-containing film is formed on the surface of the base material 11 (typically, the surface of the partition wall 13 of the honeycomb-like base material 11a or the outer peripheral surface of the pellet-like base material). After that, the carrier-containing film is dried as required. The carrier-containing film includes the above-mentioned carrier and the above-mentioned organic binder. The surface of the carrier-containing film preferably has the above-mentioned three-dimensional network structure of the above-mentioned porous lamellar structure.

Next, the above-mentioned acid gas adsorption compound is supported on the carrier in the carrier-containing film. The acid gas adsorption compound to be used in this embodiment is preferably an acid gas adsorption compound that is a liquid under normal temperature and normal pressure. More specifically, the acid gas adsorption compound that is a liquid under normal temperature and normal pressure is applied to the carrier-containing film by the above-mentioned application method. Thus, the acid gas adsorption compound penetrates into and is supported on the carrier of the carrier-containing film. Thus, the acid gas-adsorbable particles each including the acid gas adsorption compound and the carrier are formed. That is, the acid gas adsorption layer 12 includes the acid gas-adsorbable particles and the organic binder.

The structure including the base material 11 and the acid gas adsorption layer 12 arranged on the surface of the base material 11 can be produced also in this manner.

Further, the acid gas adsorption device 100 including the base material 11, the dense layer 17, and the acid gas adsorption layer 12 may be produced, for example, by the following method. This production method includes, for example, the steps of: applying a solution of a material of the dense layer 17 to the surface of the base material 11 to form the dense layer 17; and forming the acid gas adsorption layer 12 on the surface of the dense layer 17.

In such method of producing the acid gas adsorption device 100, first, the above-mentioned material of the dense layer 17 (typically, the organic binder) is dissolved in the above-mentioned aprotic polar solvent to prepare a solution of the material of the dense layer.

Next, the solution of the material of the dense layer is applied to the surface of the base material 11 by the above-mentioned application method. The number of times of the application is appropriately changed depending on a desired thickness of the dense layer 17. After that, the coating film is dried as required.

Thus, the dense layer 17 is formed on the surface of the base material 11 (typically, the surface of the partition wall 13 of the honeycomb-like base material 11a or the outer peripheral surface of the pellet-like base material).

Next, the acid gas adsorption layer 12 is formed on the surface of the dense layer 17 in the same manner as in the above-mentioned production method.

A structure including: the base material 11; the dense layer 17 arranged on the surface of the base material 11; and the acid gas adsorption layer 12 arranged on the surface of the dense layer 17 can be produced in this manner.

### C. Acid Gas Adsorption Device Including Molded Body

In another embodiment, as illustrated in FIG. 3, the acid gas adsorption device 100 includes a molded body 21 including the above-mentioned acid gas-adsorbable particles and the above-mentioned organic binder. The molded body 21 is integrally molded into a desired shape by any appropriate molding method (typically, extrusion).

In the illustrated example, the molded body 21 is a honeycomb molded body 21a. The honeycomb molded body 21a has the same configuration as that of the above-mentioned honeycomb-like base material 11a, and can be described in the same manner as the honeycomb-like base material 11a. Specifically, the honeycomb molded body 21a includes the partition wall 13 that defines the plurality of cells 14. The honeycomb molded body 21a may further include the outer wall 16 in addition to the partition wall 13. In the honeycomb molded body 21a, the acid gas adsorption layer 12 is prevented from being formed on the partition wall 13. Accordingly, the entire internal space of each of the cells 14 functions as the gas flow passage 15.

The partition wall 13 of the honeycomb molded body 21a includes the above-mentioned acid gas-adsorbable particles and the above-mentioned organic binder. A surface 13s of the partition wall 13 faces the gas flow passage 15, and is capable of being brought into contact with the acid gas to be supplied in the adsorption step. The acid gas-adsorbable particles and the organic binder are present on the surface 13s. That is, the surface 13s of the partition wall 13 is the “surface capable of being brought into contact with an acid gas” described in the above-mentioned section A, and preferably has the above-mentioned three-dimensional network structure of the above-mentioned porous lamellar structure.

The porosity of the partition wall 13 may be appropriately set depending on the purposes. The porosity of the partition wall 13 is, for example, 15% or more, preferably 20% or more, and is, for example, 70% or less, preferably 45% or less.

The bulk density of the partition wall 13 may be appropriately set depending on the purposes. The bulk density is, for example, 0.1 g/cm³ or more, preferably 0.2 g/cm³ or more, and is, for example, 0.6 g/cm³ or less, preferably 0.5 g/cm³ or less.

The molded body 21 (typically, the honeycomb molded body 21a) may include any appropriate additive in addition to the acid gas-adsorbable particles and the organic binder. Examples of the additive include a pore forming material and a surfactant. Of those, a pore forming material is preferred.

The total content ratio of the acid gas-adsorbable particles and the organic binder in the molded body 21 is, for example, 30 vol % or more, preferably 50 vol % or more, and is, for example, 100 vol % or less, preferably 99 vol % or less.

The content ratio of the acid gas-adsorbable particles in the molded body 21 is, for example, 5 vol % or more, preferably 30 vol % or more. When the content ratio of the acid gas-adsorbable particles is equal to or more than the above-mentioned lower limits, the acid gas adsorption performance of the acid gas adsorption device can be sufficiently ensured. The upper limit of the content ratio of the acid gas-adsorbable particles is typically 85 vol % or less.

The content ratio of the organic binder in the molded body 21 is, for example, 5 vol % or more, preferably 15 vol % or more. When the content ratio of the organic binder is equal to or more than the above-mentioned lower limits, the escaping of the acid gas-adsorbable particles from the molded body can be suppressed in the adsorption step and/or the desorption step described later. The upper limit of the content ratio of the organic binder is typically 70 vol % or less.

### C-1. Acid Gas Adsorption Device Including Pellet Molded Body

The acid gas adsorption device 100 illustrated in FIG. 3 includes the honeycomb molded body 21a as the molded body 21 as described above, but the shape of the molded body 21 is not limited thereto. In one embodiment, the molded body 21 is a pellet molded body.

As illustrated in FIG. 4, an acid gas adsorption device including pellet molded bodies can be described in the same manner as the acid gas adsorption device including the pellet structures except that the pellet structures 32 are changed to pellet molded bodies 35.

The plurality of pellet molded bodies 35 are filled in an inside of the flexible fiber member 33 having a hollow shape (bag shape). The average primary particle diameter of the pellet molded body is, for example, 60 μm or more and 1,200 μm or less. The range of the porosity of the pellet molded body is the same as the above-mentioned range of the porosity of the partition wall, and the range of the bulk density of the pellet molded body is the same as the above-mentioned range of the bulk density of the partition wall.

A peripheral surface of each of the pellet molded bodies 35 is capable of being brought into contact with the acid gas to be supplied in the adsorption step. The acid gas-adsorbable particles and the organic binder are present on the peripheral surface of each of the pellet molded bodies 35. That is, the peripheral surface of each of the pellet molded bodies 35 is the “surface capable of being brought into contact with an acid gas” described in the above-mentioned section A, and preferably has the above-mentioned three-dimensional network structure or the above-mentioned porous lamellar structure.

### C-2. Method of Producing Acid Gas Adsorption Device Including Molded Body

Next, a method of producing the acid gas adsorption device 100 including the molded body 21 is described.

The method of producing the acid gas adsorption device 100 including the molded body 21 includes the steps of: mixing the acid gas-adsorbable particles, the organic binder, and the aprotic polar solvent to prepare a body; molding the body to prepare a precursor; and replacing the aprotic polar solvent in the precursor to form the molded body 21.

In such method of producing the acid gas adsorption device 100, first, the above-mentioned acid gas-adsorbable particles, the above-mentioned organic binder, and the above-mentioned aprotic polar solvent (good solvent) are mixed by any appropriate method to prepare a body. At this time, an additive (typically, a pore forming material) is further added as required.

The addition ratio of each of the acid gas-adsorbable particles and the organic binder may be adjusted to any appropriate value, for example, so that the mass ratio of the organic binder to the acid gas-adsorbable particles falls within the above-mentioned range.

The addition ratio of the acid gas-adsorbable particles is, for example, 30 parts by mass or more, preferably 50 parts by mass or more, and is, for example, 99 parts by mass or less, preferably 85 parts by mass or less with respect to 100 parts by mass of the aprotic polar solvent.

The addition ratio of the organic binder is, for example, 1 part by mass or more, preferably 15 parts by mass or more, and is, for example, 70 parts by mass or less, preferably 50 parts by mass or less with respect to 100 parts by mass of the aprotic polar solvent.

A temperature at the time of the mixing of those components is, for example, −10° C. or more, preferably 0° C. or more, and is, for example, 60° C. or less, preferably 30° C. or less.

Thus, the body (molding raw material) is prepared.

Next, the body is molded into a desired shape by any appropriate molding method (typically, extrusion). Thus, a precursor having a desired shape (typically, a honeycomb-like shape or a pellet-like shape) is prepared. The precursor includes the above-mentioned acid gas-adsorbable particles, the above-mentioned organic binder, and the above-mentioned aprotic polar solvent.

Next, the aprotic polar solvent in the precursor is replaced with the above-mentioned poor solvent. Thus, the above-mentioned molded body 21 is formed. After that, the molded body 21 is dried as required. A drying temperature is, for example, 25° C. or more and 200° C. or less. A drying time period is, for example, 1 minute or more and 10 hours or less.

As described above, the molded body 21 having a desired shape is produced.

More specifically, as illustrated in FIG. 3, when the molded body 21 is the honeycomb molded body 21a, the acid gas adsorption device 100 formed of the honeycomb molded body 21a is produced.

In addition, when the molded body 21 is the pellet molded body, the acid gas adsorption device illustrated in FIG. 4 can be produced through use of the pellet molded body.

### D. Operation of Acid Gas Adsorption Device 100

The acid gas adsorption device 100 according to one embodiment may be repeatedly subjected to: an adsorption step of causing an acid gas in a gas to be treated to be adsorbed to the acid gas-adsorbable particles; and a desorption step of causing the acid gas to be desorbed from the acid gas-adsorbable particles.

In the adsorption step, typically, the gas to be treated including the acid gas is supplied to the acid gas adsorption device at a predetermined adsorption temperature, and the acid gas is brought into contact with the acid gas-adsorbable particles. Thus, the acid gas is adsorbed to the acid gas-adsorbable particles.

The temperature (adsorption temperature) of the acid gas adsorption device in the adsorption step is, for example, 0° C. or more, preferably 10° C. or more, and is, for example, 50° C. or less, preferably 40° C. or less. In one embodiment, the adsorption temperature is the same temperature as an outside air temperature. The operation time period (adsorption time period) of the adsorption step is, for example, 15 minutes or more, preferably 30 minutes or more, and is, for example, 3 hours or less, preferably 2 hours or less.

When the adsorption temperature and/or the adsorption time period fall within the above-mentioned ranges, the acid gas can be efficiently adsorbed to the acid gas-adsorbable particles.

The capture rate of the acid gas in the adsorption step (=100−(concentration of acid gas in gas to be treated having passed through acid gas adsorption device/concentration of acid gas in gas to be treated before being supplied to acid gas adsorption device×100)) is, for example, 60% or more, preferably 75% or more, more preferably 80% or more, particularly preferably 90% or more, and is, for example, 100% or less.

In the desorption step, typically, the acid gas adsorption device is heated to a desorption temperature exceeding the adsorption temperature. More specifically, in the desorption step, the temperature of the acid gas adsorption device is increased to the desorption temperature, and is then maintained at the desorption temperature for a predetermined desorption time period.

In one embodiment, the temperature of the acid gas adsorption device is increased to the desorption temperature by supplying water vapor to the acid gas adsorption device. The temperature of the water vapor is, for example, 50° C. or more and 200° C. or less. The acid gas adsorption device according to one embodiment includes the organic binder having excellent water resistance, and hence the temperature thereof can be increased through use of the water vapor.

After that, a desorption gas is supplied to the acid gas adsorption device at the desorption temperature, and the acid gas having been desorbed is captured together with the desorption gas. A gas captured in the desorption step is sometimes referred to as “capture gas.” Preferred examples of the desorption gas include water vapor and the capture gas having been preliminarily captured in the acid gas adsorption device. When the capture gas is utilized as the desorption gas, an increase in concentration of the acid gas in the capture gas can be achieved. The temperature of the desorption gas to be supplied to the acid gas adsorption device is, for example, 60° C. or more, preferably 90° C. or more, and is, for example, 200° C. or less, preferably 160° C. or less.

In the desorption step, the acid gas may be captured without using the desorption gas. For example, the acid gas having been desorbed may be captured through suction with a decompression pump. In addition, the desorption gas and the decompression pump may be used in combination.

The temperature (desorption temperature) of the acid gas adsorption device in the desorption step is, for example, 70° C. or more, preferably 80° C. or more, and is, for example, 200° C. or less, preferably 110° C. or less. The operation time period of the desorption step (desorption time period for which the acid gas adsorption device is maintained at the desorption temperature) is, for example, 1 minute or more, preferably 5 minutes or more, and is, for example, 1 hour or less, preferably 30 minutes or less. When the desorption temperature and/or the desorption time period fall within the above-mentioned ranges, the oxidative degradation and volatilization of the acid gas-adsorbable particles can be suppressed.

As described above, the acid gas having been adsorbed to the acid gas-adsorbable particles in the adsorption step can be desorbed from the acid gas-adsorbable particles, and the acid gas having been desorbed can be captured.

The acid gas adsorption device according to one embodiment may be subjected to a cycle of the adsorption step and the desorption step, for example, 10 times or more, preferably 30 times or more, more preferably 50 times or more, still more preferably 100 times or more.

### E. Recycle of Organic Binder

After the adsorption step and the desorption step are performed (preferably, after the cycle of the adsorption step and the desorption step is performed within the above-mentioned ranges), the organic binder in the acid gas adsorption device may be collected and reused (recycled). In addition, the collection of the organic binder may be performed after the capture rate of the acid gas in the adsorption step becomes less than the above-mentioned lower limit. Thus, the organic binder of the acid gas adsorption layer, which has come to the end of the lifetime, can be effectively utilized.

When the acid gas adsorption device 100 includes the base material 11 and the acid gas adsorption layer 12, in the collection of the organic binder, the above-mentioned aprotic polar solvent is brought into contact with the acid gas adsorption layer 12. For example, when the base material 11 is the honeycomb-like base material 11a, the aprotic polar solvent is caused to flow through the gas flow passage 15 so that the aprotic polar solvent is brought into contact with the acid gas adsorption layer 12. Thus, the organic binder in the acid gas adsorption layer is dissolved in the aprotic polar solvent, and the acid gas-adsorbable particles are separated from the base material.

The aprotic polar solvent with which the acid gas adsorption layer has been removed includes the acid gas-adsorbable particles and the organic binder. Accordingly, the acid gas-adsorbable particles are removed from the aprotic polar solvent including the acid gas-adsorbable particles and the organic binder through, for example, filtration, followed by addition of a protic polar solvent (typically, water) to the aprotic polar solvent including the organic binder. In this manner, only the organic binder can be precipitated, and the organic binder can be reused.

In addition, when the acid gas adsorption device 100 includes the molded body 21, in the collection of the organic binder, the molded body 21 is pulverized. Any appropriate method may be adopted as a pulverization method for the molded body depending on a material of the molded body. Examples of the pulverization method include methods using a hammer mill, a roller mill, a jet mill, and a ball mill. Thus, material powder is obtained.

The material powder includes the acid gas-adsorbable particles and the organic binder. Next, the material powder is added to the above-mentioned aprotic polar solvent and stirred. Thus, the organic binder is dissolved in the aprotic polar solvent. After that, in the same manner as described above, the acid gas-adsorbable particles are removed from the aprotic polar solvent including the acid gas-adsorbable particles and the organic binder, followed by addition of a protic polar solvent to a filtrate, to thereby precipitate only the organic binder. The organic binder can be reused also in this manner.

### EXAMPLES

The present invention is specifically described below by way of Examples, but the present invention is not limited by these Examples.

### Example 1

A body including alumina, silica, and magnesia (i.e., cordierite) was extruded and then dried. Thus, a honeycomb-like base material illustrated in FIG. 1 was prepared. The honeycomb-like base material had a cylindrical shape with a diameter of 28 mm and a length of 60 mm. The honeycomb-like base material included a partition wall that defined a plurality of cells and an outer peripheral wall that surrounded the partition wall. The sectional shapes of the cells were each a quadrangle. The honeycomb-like base material had a cell density of 62 cells/cm², and the partition wall had a thickness of 0.1 mm and a porosity of 40%.

10 Parts by mass of polyvinylidene fluoride (PVDF, organic binder, weight average molecular weight Mw: 50,000, solubility in water at 25° C.: 0.03 g/100 g-H₂O, melting point: 173° C., decomposition temperature: 280° C.) was dissolved in 90 parts by mass of N-methyl-2-pyrrolidone (NMP, aprotic polar solvent). Thus, a binder solution having a concentration of 10 vol % was prepared.

Next, 10 parts by mass of an amine-supporting polymer including polyethyleneimine as a main component (average primary particle diameter: 5 μm) was added to the binder solution. The amine-supporting polymer was then dispersed in the binder solution through planetary stirring. The particle diameter of a sol measured by a dynamic light scattering method was 20 μm.

Next, the binder solution having dispersed therein the amine-supporting polymer was caused to flow through the cells of the honeycomb-like base material under normal temperature and normal pressure (23° C., 0.1 MPaA (absolute pressure)). Thus, the binder solution having dispersed therein the amine-supporting polymer was applied to the surface of the partition wall of the honeycomb-like base material to form a precursor film including the amine-supporting polymer and PVDF. The precursor film had a thickness (wet thickness) of 200 μm.

Next, the honeycomb-like base material having formed therein the precursor film was immersed in water (poor solvent for PVDF) under normal temperature and normal pressure for 10 minutes. Thus, NMP in the precursor film was replaced with water to form an acid gas adsorption layer including the amine-supporting polymer and PVDF. After that, the honeycomb-like base material was pulled out of water, and the acid gas adsorption layer was dried at 50° C. for 120 minutes.

As described above, an acid gas adsorption device (carbon dioxide adsorption device) including the honeycomb-like base material and the acid gas adsorption layer (carbon dioxide adsorption layer) was produced.

In the acid gas adsorption layer, the content ratio of the amine-supporting polymer was 50 vol %, and the content ratio of PVDF was 50 vol %. The surface shape of the acid gas adsorption layer observed with a scanning electron microscope was a porous lamellar structure. The acid gas adsorption layer had a thickness of 180 μm. The acid gas adsorption layer had an average pore diameter of 5 μm.

### Example 2

A body (molding raw material) was obtained by mixing 40 parts by mass of the above-mentioned amine-supporting polymer (acid gas-adsorbable particles), 40 parts by mass of the above-mentioned PVDF, and 20 parts by mass of NMP. Next, the body was extruded into a honeycomb shape illustrated in FIG. 3. Thus, a precursor was prepared.

Next, the honeycomb-like precursor was immersed in water (poor solvent for PVDF) under normal temperature and normal pressure for 10 minutes. Thus, NMP in the precursor was replaced with water to form a honeycomb molded body including the amine-supporting polymer and PVDF. After that, the honeycomb molded body was pulled out of water, and the honeycomb molded body was dried at 50° C. for 120 minutes.

As described above, an acid gas adsorption device (carbon dioxide adsorption device) formed of the honeycomb molded body was produced. The honeycomb molded body had the same shape and size as those of the honeycomb-like base material of Example 1. The honeycomb molded body had a cell density of 62 cells/cm², and the partition wall had a porosity of 30%.

In the honeycomb molded body, the content ratio of the amine-supporting polymer was 50 volt, and the content ratio of PVDF was 50 vol %. The surface shape of the partition wall observed with a scanning electron microscope was a porous lamellar structure. The honeycomb molded body had an average pore diameter of 5 μm.

### <Evaluation of CO₂ Adsorption and Desorption>

The acid gas adsorption device (carbon dioxide adsorption device) obtained in each of Examples was accommodated in a quartz tube reactor so that its cell extending direction was parallel to a vertical direction. Next, the gas flow passage was degassed at 100° C. in nitrogen, and then, the acid gas adsorption device was cooled to room temperature (23° C.). A mixed gas (0.04 vol % of CO₂ in nitrogen) was caused to flow through the gas flow passage of the acid gas adsorption device at 25° C. and a flow rate of 2 m/sec for 15 minutes. The concentration of CO₂ in the mixed gas having passed through the gas flow passage was measured, and the capture rate (%) of CO₂ was calculated.

After that, the temperature of the acid gas adsorption device was increased to 100° C. (desorption temperature) by causing water vapor at 120° C. to flow through the gas flow passage of the acid gas adsorption device at a flow rate of 2 m/sec for 15 minutes.

Next, CO₂ was desorbed from the CO₂ adsorption material (the acid gas adsorption device was regenerated) by causing water vapor at 120° C. to flow through the gas flow passage of the acid gas adsorption device at a flow rate of 2 m/sec for 15 minutes. The repetition of such adsorption of CO₂ and such desorption of CO₂ was defined as one cycle. This cycle was repeated 10 times.

The acid gas adsorption device of Example 1 had a capture rate of CO₂ of 90% or more in all the cycles, and the acid gas adsorption device of Example 2 had a capture rate of CO₂ of 90% or more in all the cycles.

The method of regenerating an acid gas adsorption device according to each of the embodiments of the present invention can be used for regeneration of an acid gas adsorption device to be used for separation and capture of an acid gas, and particularly, can be suitably used for regeneration of a carbon dioxide adsorption device to be used for a Carbon dioxide Capture, Utilization and Storage (CCUS) cycle.

What is claimed is:

1. An acid gas adsorption device, comprising:
particles each having an acid gas adsorption ability; and
an organic binder capable of binding the particles,
the organic binder being soluble in an aprotic polar solvent and being substantially insoluble in a protic polar solvent.

2. The acid gas adsorption device according to claim 1,
wherein the acid gas adsorption device has a surface which is capable of being brought into contact with an acid gas and on which the particles and the organic binder are present, and
wherein the surface has one of a three-dimensional network structure or a porous lamellar structure.

3. The acid gas adsorption device according to claim 1, wherein the organic binder is an organic binder for which at least water is a poor solvent.

4. The acid gas adsorption device according to claim 1, wherein the acid gas adsorption device comprises:
a base material; and
an acid gas adsorption layer arranged on a surface of the base material, the acid gas adsorption layer including the particles and the organic binder.

5. The acid gas adsorption device according to claim 1, wherein the acid gas adsorption device comprises a molded body including the particles and the organic binder.

6. The acid gas adsorption device according to claim 2, wherein the acid gas adsorption device comprises:
an acid gas adsorption layer including the particles and the organic binder;
a dense layer configured to be denser than the acid gas adsorption layer; and
a base material, in the stated order.

7. The acid gas adsorption device according to claim 1, wherein the acid gas is carbon dioxide.

8. A method of producing an acid gas adsorption device, comprising:
dispersing particles each having an acid gas adsorption ability in a binder solution having an organic binder dissolved in an aprotic polar solvent, the organic binder being soluble in the aprotic polar solvent and being substantially insoluble in a protic polar solvent;
applying the binder solution having dispersed therein the particles to a surface of a base material to form a precursor film; and
replacing the aprotic polar solvent in the precursor film with a poor solvent for the organic binder to form an acid gas adsorption layer including the particles and the organic binder.

9. A method of producing an acid gas adsorption device, comprising:
mixing particles each having an acid gas adsorption ability, an organic binder that is soluble in an aprotic polar solvent and that is substantially insoluble in a protic polar solvent, an aprotic polar solvent in which the organic binder is soluble and in which the particles are substantially insoluble to prepare a body;
molding the body to prepare a precursor including the particles and the organic binder; and
replacing the aprotic polar solvent in the precursor with a poor solvent for the organic binder to prepare a molded body including the particles and the organic binder.

10. A method of producing d gas adsorption device, comprising:
dispersing a carrier in a binder solution having an organic binder dissolved in an aprotic polar solvent, the organic binder being soluble in the aprotic polar solvent and being substantially insoluble in a protic polar solvent;
applying the binder solution having dispersed therein the carrier to a surface of a base material to form a precursor film;
replacing the aprotic polar solvent in the precursor film with a poor solvent for the organic binder to form a carrier-containing film including the carrier and the organic binder; and
causing an acid gas adsorption compound to be supported on the carrier in the carrier-containing film to form an acid gas adsorption layer including: particles each formed of the acid gas adsorption compound and the carrier; and the organic binder.
